(19) United States
(12) Patent Application Publication
(10) Pub. No.: US 2020/0180538 A1
(43) Pub. Date: Jun. 11, 2020

(54) DIAGNOSTIC PEDESTRIAN PROTECTION SYSTEM AND RELATED METHODS

(71) Applicant: Continental Automotive Systems, Inc., Auburn Hills, MI (US)

(72) Inventors: Arturo Gonzalez Laurel, Zapopan (MX); Cristyel Cruz Gonzalez, Tlaquepaque (MX); Fernando Lozano Gonzalez, Guadalajara (MX)

(73) Assignee: Continental Automotive Systems, Inc., Auburn Hills, MI (US)

(21) Appl. No.: 16/211,588

(22) Filed: Dec. 6, 2018

(51) Int. Cl. B60R 21/017; B60R 21/36

(52) U.S. Cl. CPC B60R 21/0173; B60R 2021/01068; B60R 21/36

(57) ABSTRACT

A diagnostic pedestrian protection system includes a pedestrian protection system having at least two impact detection sensors connected to each other by a conduit, where the impact detection sensor configured to measure a differential condition of the pedestrian protection system. The impact detection sensor communicatively coupled with an air bag module that is configured to evaluate if the pedestrian protection system is inoperable using the measured differential condition of the pedestrian protection system.

### TECHNICAL FIELD

The disclosure herein relates to diagnostic features for a pedestrian protection system.

### TECHNICAL BACKGROUND

Pedestrian protection systems are available and include vehicle-mounted safety systems for helping to prevent injury to pedestrians in the event of contact with a moving vehicle.

When a pedestrian is hit by a car, one type of injury can be caused by a subsequent collision between the pedestrian's head and the hood of the vehicle. Many impact protection systems have been devised to reduce the effects of such collisions, for example cushioning devices such as hood-mounted airbags or energy-absorbing hood panels.

The cushioning devices require a sensor to be used to detect pedestrian impacts. Once the sensor has confirmed physical impact with a pedestrian, a protective device is rapidly deployed. The decision of whether to deploy or not to deploy must be made in a very short period of time after detecting an initial impact at the front of the vehicle, and it is important that the sensor and related components are in working condition.

If the pedestrian protection system is inoperable, the protective device may not be deployed. What is needed is a way to evaluate whether the pedestrian protection system is inoperable prior to or while using the vehicle.

### BRIEF SUMMARY

A diagnostic pedestrian protection system includes a pedestrian protection system having at least two impact detection sensors connected to each other by a conduit, where the impact detection sensor configured to measure a differential condition of the pedestrian protection system. The impact detection sensor communicatively coupled with an air bag module that is configured to evaluate if the pedestrian protection system is inoperable using the measured differential condition of the pedestrian protection system. For example, the airbag module monitors the pressure differential between two sensors to determine if the system if operable.

In one or more embodiments, the airbag module is configured to evaluate if the pedestrian protection system is inoperable during an ignition cycle.

In one or more embodiments, the airbag module is configured to measure a pressure differential between the at least two impact detection sensors.

In one or more embodiments, the impact detection sensor configured to measure a pressure differential between a right sensor and a left sensor.

In one or more embodiments, the system with diagnostic features further includes a communications module.

In one or more embodiments, the communications module is configured to send a notification if the pressure differential is different than zero.

In one or more embodiments, the system with diagnostic features further includes an airbag module and communications module is part of the airbag module.

In one or more embodiments, the airbag module is configured to evaluate if the pedestrian protection system is inoperable while traveling a speed of less than 25 kph.

In one or more embodiments, the system with diagnostic features further includes at least one deformation element disposed adjacent to the pedestrian protection system.

In one or more embodiments, the at least one impact detection sensor is a pressure sensor.

In one or more embodiments, a method includes testing a condition in a pedestrian protection system having at least one impact detection sensor, the impact detection sensor configured to measure the condition of the pedestrian protection system, the impact detection sensor communicatively coupled with an airbag module. The method further includes evaluating with the airbag module whether the pedestrian protection system is inoperable using the measured condition of the pedestrian protection system.

In one or more embodiments, the method further includes evaluating whether the pedestrian protection system is inoperable during at least one ignition cycle.

In one or more embodiments, the method further includes evaluating whether the pedestrian protection system is inoperable during each ignition cycle.

In one or more embodiments, wherein the pedestrian protection system includes two impact detection sensors, and further comprising measuring a pressure differential between the two impact detection sensors to determine whether the pedestrian protection system is inoperable.

In one or more embodiments, the method further includes measuring a pressure differential at a right sensor and a left sensor.

In one or more embodiments, the method further includes sending a notification if the pressure differential between the two impact detection sensors is different than zero.

In one or more embodiments, the method further includes an airbag module and a communications module is part of the airbag module, wherein sending the notification if the pressure differential between the two impact detection sensors is different than zero includes sending the notification with the communications module.

In one or more embodiments, evaluating whether the pedestrian protection system is inoperable occurs while traveling a speed of less than 25 kph.

In one or more embodiments, evaluating whether the pedestrian protection system is inoperable ceases while traveling greater than 25 kph.

### BRIEF DESCRIPTION OF THE DRAWINGS

FIG. 1 illustrates a vehicle with diagnostic pedestrian protection system, as constructed in accordance with one or more embodiments.

FIG. 2 illustrates an impact detection sensor of the diagnostic pedestrian protection system, as constructed in accordance with one or more embodiments.

FIG. 3 illustrates an impact detection sensor of the diagnostic pedestrian protection system, as constructed in accordance with one or more embodiments.

FIG. 4 illustrates an impact detection sensor of the diagnostic pedestrian protection system, as constructed in accordance with one or more embodiments.

FIG. 5 illustrates a top cross-sectional view of a diagnostic pedestrian protection system, as constructed in accordance with one or more embodiments.

FIG. 6 illustrates an impact detection sensor, as constructed in accordance with one or more embodiments.

FIG. 7 illustrates a top cross-sectional view of a diagnostic pedestrian protection system, as constructed in accordance with one or more embodiments.

FIG. 8 illustrates a top cross-sectional view of a diagnostic pedestrian protection system, as constructed in accordance with one or more embodiments.

FIG. 9 illustrates a vehicle with a diagnostic pedestrian protection system, as constructed in accordance with one or more embodiments.

FIG. 10 illustrates a schematic diagram of a diagnostic pedestrian protection system, as constructed in accordance with one or more embodiments.

FIG. 11 illustrates a schematic diagram of a diagnostic pedestrian protection system, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

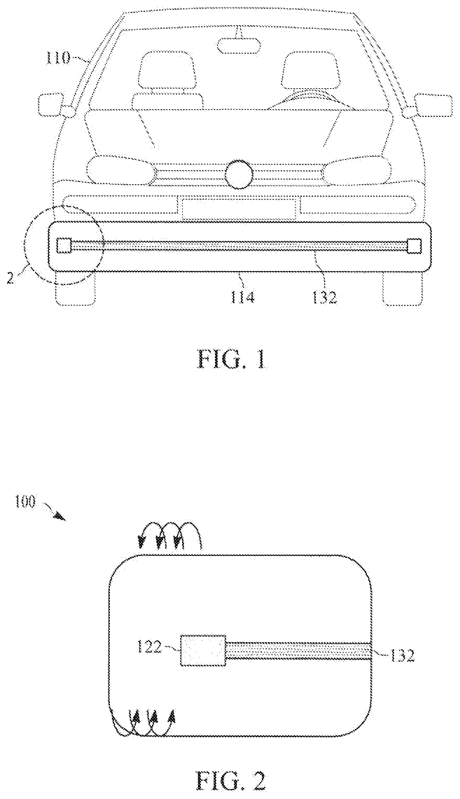

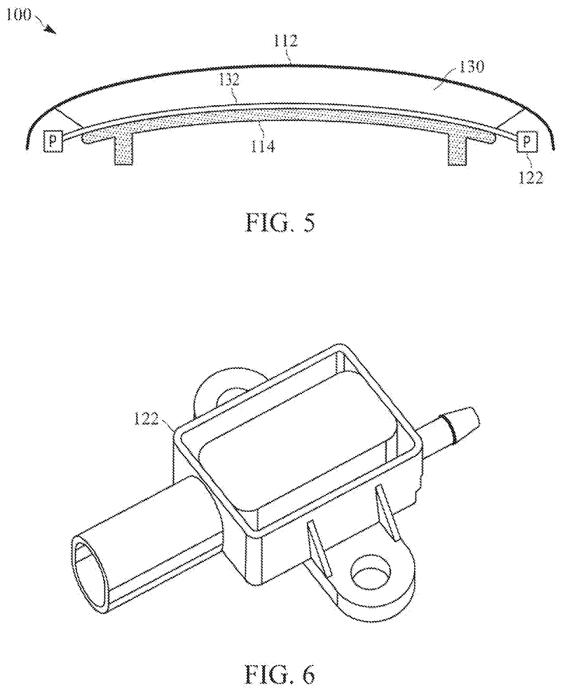

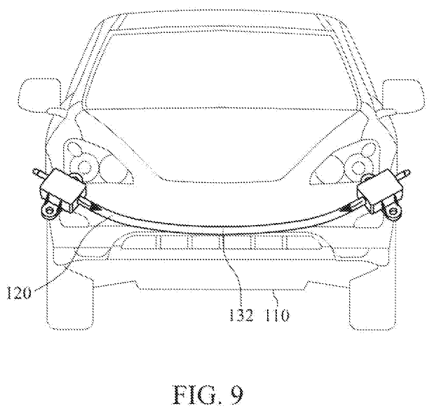

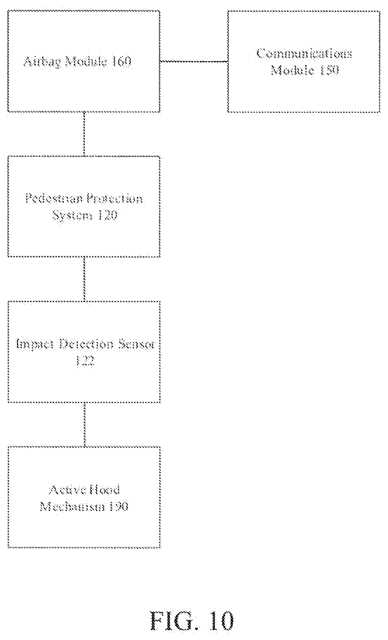

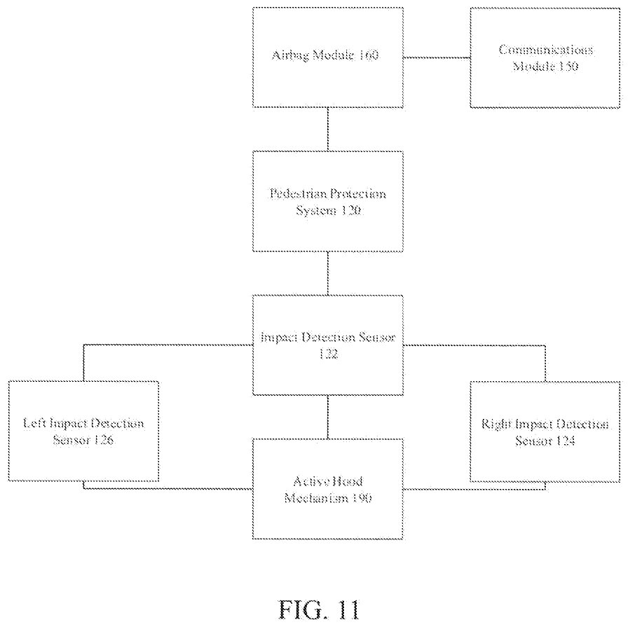

FIGS. 1-11 show various views of a diagnostic pedestrian protection system 100 in accordance with embodiments described herein. In one or more embodiments, the diagnostic pedestrian protection system 100 is included within the structure of a vehicle 110, as shown in FIGS. 5-9. In one or more embodiments, the diagnostic pedestrian protection system 100 includes a pedestrian protection system 120 having at least two impact detection sensors 122 which are connected to each other with a conduit 132. The at least two impact detection sensors 122 are configured to measure a differential condition of the pedestrian protection system 120, such as, but not limited to a pressure variation between the at least two impact detection sensors 122. In one or more embodiments, the pedestrian protection system is mounted on an area of a vehicle area which allows air flow, as shown in FIGS. 2-4. The air flow enables the impact detection sensors to detect pressure changes when the conduit is detached.

The at least two impact detection sensors 122 are communicatively coupled with an airbag module 160, which optionally includes a processor. The airbag module 160 is configured to evaluate if the pedestrian protection system 120 is inoperable using the measured differential condition of the pedestrian protection system 120. For example, the measured differential condition of the pedestrian protection system 120 includes measuring a pressure differential condition of the pedestrian protection system 120 at the impact detection sensor 122. In one or more embodiments, measuring the pressure differential condition includes measuring if the pressure at the impact detection sensor 122 had changed from a previous reading. For example, if a lower pressure is measured, a pressure differential different than zero has been measured indicating the pedestrian protection system 120 is inoperable.

The pedestrian protection system 120 further optionally includes a pressurized fluid source coupled with a conduit 132 (FIGS. 2-4, 7, 8), where the conduit 132 is coupled with each of the at least two impact detection sensors 122. The pressurized fluid source supplies pressurized fluid (for example, compressed air, a compressed gas, or a hydraulic fluid such as an oil) to the conduit 132, and when the conduit 132 is properly connected to the at least one impact detection sensor 122, the pressurized fluid source supplies pressurized fluid to the at least one impact detection sensor 122. The at least one at least two impact detection sensors 122 are configured to sense whether there has been pedestrian impact, for example by measuring pressure within the conduit 132 and/or at the at least one impact detection sensor 122.

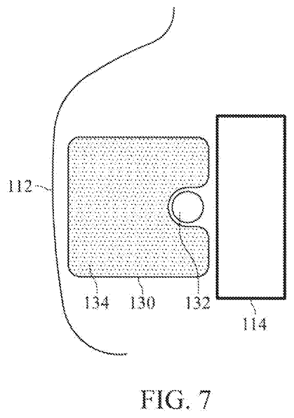

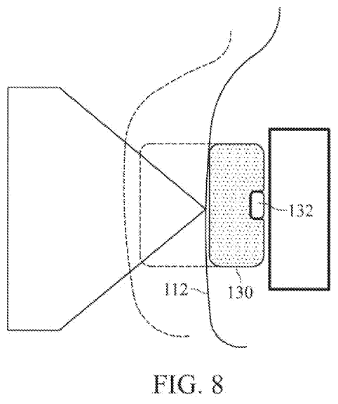

The vehicle 110 is shown in greater detail in FIGS. 5, 7-9. The vehicle 110 includes a front end 112 and a bumper 114. In one or more embodiments, a deformation member 130 is disposed between the front end 112 and the bumper 114 and is configured to deform in the event of an impact. In one or more embodiments, the conduit 132 is disposed within a recess 134 of the deformation member 130, as shown in FIGS. 7 and 8 and is adjacent to the bumper such that the conduit 132 will collapse during a collision, and the pressure within the conduit will increase.

The deformation member 130 is made of deformable material including, but not limited to, foam. FIG. 7 illustrates a condition prior to collision with a pedestrian. As shown, the deformation member 130 is not deformed, and is disposed between the front end 112 and the bumper 114. When an impact occurs, and force is applied to the front end 112 as shown in FIG. 8, the deformation member 130 is deformed and energy is absorbed by the deformation member 130. The conduit 132, optionally disposed within the recess 134, is compressed during the impact.

The pedestrian protection system 120 further optionally includes a vehicle speed information source (for example, an on-board speed sensor) communicatively coupled with the airbag module 160. In one or more embodiments, the pedestrian protection system 120 is configured so that when the vehicle is stationary or moving at a speed below a predetermined threshold speed V, airbag module 160 is configured to evaluate if the pedestrian protection system 120 is operable or inoperable. For example, the processor is configured to evaluate of the pedestrian protection system is inoperable until the vehicle reaches a speed V. In one or more embodiments, the airbag module 160 is configured to evaluate if the pedestrian protection system 120 is inoperable while traveling a speed of less than 25 kph. In one or more embodiments, the airbag module 160 includes a processor with an algorithm to evaluate whether the pedestrian protection system is inoperable. In one or more embodiments, the evaluation occurs while traveling a speed of less than 25 kph.

In one or more embodiments, the diagnostic pedestrian protection system 100 further includes an active hood mechanism 190 which is activated when compression of the deformation member 130 is detected by the at least one impact detection sensor 122. The active hood mechanism 190 is structured and positioned to make direct contact with the pedestrian in the event of a collision between the pedestrian and the vehicle. When the pedestrian contacts the active hood mechanism 190, the contact energy is transferred to the active hood mechanism 190 to aid in cushioning the pedestrian impact.

In one or more embodiments, the active hood mechanism 190 is structured to absorb at least a portion of the pedestrian-vehicle contact energy when the active hood mechanism 190 is in a deployed position. For example, the active hood mechanism 190 may be formed from a suitable energy-absorbing material (for example, an inflatable airbag or bladder) actuatable by a pressurized fluid and provided with a pressure relief valve or another suitable mechanism for controlled venting of the pressurized fluid contained therein, responsive to pedestrian-vehicle contact forces and/or to vent gases in the inflatable device while it is maintained in the inflated condition. Also, additional arrangements may be provided with a relief valve or other mechanism for venting pressurized fluid or otherwise enabling a reduction in the actuation pressure responsive to contact between the pedestrian and the active hood mechanism. This aids the mechanism in absorbing the pedestrian-vehicle contact forces in a controlled manner.

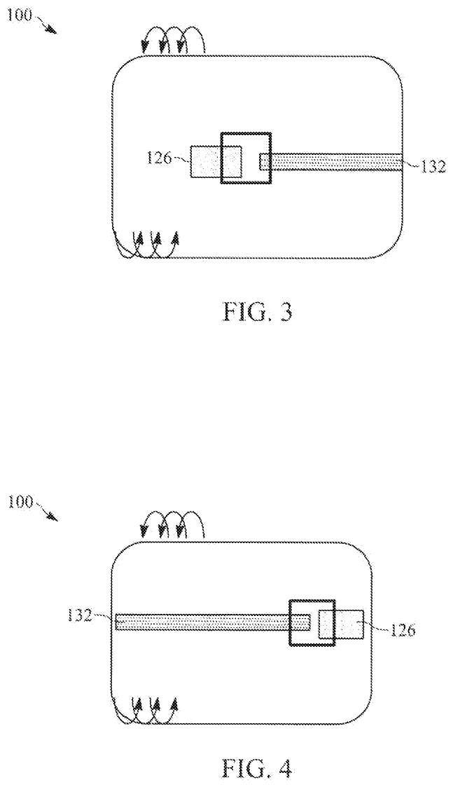

In one or more embodiments, a method includes testing a condition in a pedestrian protection system having at least two impact detection sensors connected to each other by a conduit, the impact detection sensor is configured to measure the condition of the pedestrian protection system, the impact detection sensor communicatively coupled with an airbag module. The method further includes evaluating with the processor whether the pedestrian protection system is inoperable using the measured condition of the pedestrian protection system. In one or more embodiments, the processor is configured to evaluate whether the pedestrian protection system 120 is operable using the differential measurement of the condition, such as pressure. In one example, a pressure variation is detected by a left impact detection sensor 126, indicating low pressure and that the conduit 132 (hose) is uncoupled from the impact detection sensor 122 (FIG. 3). In another example, a pressure variation is detected by a right impact detection sensor 124, indicating low pressure and that the conduit 132 (hose) is uncoupled from the impact detection sensor 122 (FIG. 4). In another embodiment, low pressure can be detected at both left and right sensors 126, 124 indicating the conduit 132 (hose) is uncoupled from both sensors.

In one or more embodiments, evaluating whether the pedestrian protection system is inoperable during at least one ignition cycle. In one or more embodiments, evaluating whether the pedestrian protection system is inoperable during each ignition cycle.

In one or more embodiments, wherein the pedestrian protection system includes two impact detection sensors, and further comprising measuring a pressure differential of each of the impact detection sensors to determine whether the pedestrian protection system is inoperable.

In one or more embodiments, the method further includes measuring a pressure differential at both a right sensor and a left sensor. In one or more embodiments, the method further includes sending a notification if the pressure differential between the impact detection sensors is different than zero.

In one or more embodiments, the method further includes an airbag module and a communications module is part of the airbag module, wherein sending the notification if the pressure differential between the impact detection sensors is different than zero includes sending the notification with the communications module.

In one or more embodiments, evaluating whether the pedestrian protection system is inoperable occurs while traveling a speed of less than 25 kph. In one or more embodiments, evaluating whether the pedestrian protection system is inoperable ceases while traveling greater than 25 kph.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A diagnostic pedestrian protection system comprising:
a pedestrian protection system having at least two impact detection sensors connected to each other by a conduit;
the impact detection sensor configured to measure a differential condition of the pedestrian protection system; and
the impact detection sensor communicatively coupled with an airbag module, the airbag module configured to evaluate if the pedestrian protection system is inoperable using the measured differential condition of the pedestrian protection system.

2. The diagnostic pedestrian protection system as recited in claim 1, wherein the airbag module is configured to evaluate if the pedestrian protection system is inoperable during an ignition cycle.

3. The diagnostic pedestrian protection system as recited in claim 1, wherein the pedestrian protection system includes two impact detection sensors, and the airbag module is configured to measure a pressure differential between the two impact detection sensors.

4. The diagnostic pedestrian protection system as recited in claim 3, wherein the impact detection sensor configured to measure a pressure differential at both a right sensor and a left sensor.

5. The diagnostic pedestrian protection system as recited in claim 3, further comprising a communications module.

6. The diagnostic pedestrian protection system as recited in claim 5, wherein the communications module is configured to send a notification if the pressure differential is different than zero.

7. The diagnostic pedestrian protection system as recited in claim 5, further comprising an airbag module and communications module is part of the airbag module.

8. The diagnostic pedestrian protection system as recited in claim 1, wherein the airbag module is configured to evaluate if the pedestrian protection system is inoperable while traveling a speed of less than 25 kph.

9. The diagnostic pedestrian protection system as recited in claim 1, further comprising at least one deformation element disposed adjacent to the pedestrian protection system.

10. The diagnostic pedestrian protection system as recited in claim 1, wherein the at least one impact detection sensor is a pressure sensor.

11. A method comprising:
testing a condition in a pedestrian protection system having at least two impact detection sensors connected to each other by a conduit, the impact detection sensor configured to measure a differential condition of the pedestrian protection system, the impact detection sensor communicatively coupled with an airbag module; and
evaluating with the airbag module whether the pedestrian protection system is inoperable using the measured differential condition of the pedestrian protection system.

12. The method as recited in claim 11, wherein evaluating whether the pedestrian protection system is inoperable during at least one ignition cycle.

13. The method as recited in claim 11, wherein evaluating whether the pedestrian protection system is inoperable during each ignition cycle.

14. The method as recited in claim 11, further comprising measuring a pressure differential between the two impact detection sensors to determine whether the pedestrian protection system is inoperable.

15. The method as recited in claim 14, further comprising measuring a pressure differential at both a right sensor and a left sensor.

16. The method as recited in claim 14, further comprising sending a notification if the pressure differential between the two impact detection sensors is different than zero.

17. The method as recited in claim 16, further comprising an airbag module and a communications module is part of the airbag module, wherein sending the notification if the pressure differential between the two impact detection sensors is different than zero includes sending the notification with the communications module.

18. The method as recited in claim 11, wherein evaluating whether the pedestrian protection system is inoperable occurs while traveling a speed of less than or equal to 25 kph.

19. The method as recited in claim 18, wherein evaluating whether the pedestrian protection system is inoperable ceases while traveling greater than 25 kph.
